(19) United States
(12) Patent Application Publication
(10) Pub. No.: US 2017/0326773 A1
(43) Pub. Date: Nov. 16, 2017

(54) FUSED FILAMENT FABRICATION COLOR EXTRUDER FOR THREE DIMENSIONAL PRINTING

(71) Applicant: ORD Solutions Inc., Cambridge (CA)

(72) Inventor: Christopher John Elmer GIBSON, Cambridge (CA)

(21) Appl. No.: 15/596,212

(22) Filed: May 16, 2017

Related U.S. Application Data
(60) Provisional application No. 62/336,804, filed on May 16, 2016.

(51) Int. Cl. B29C 47/04; B29C 47/88; B29K 67/00; B33Y 30/00; B29K 55/02; B33Y 10/00

(52) U.S. Cl. CPC B29C 47/04; B29C 47/8815; B29C 47/8805; B33Y 10/00; B33Y 30/00; B29K 2055/02; B29K 2067/046

(57) ABSTRACT

The present disclosure provides a print head apparatus and method for printing a multi-coloured three-dimensional object. The apparatus separately receives at least two filaments in a cold section, separately feeds the at least two filaments in a transition section, and heats the at least two filaments in a hot section. The hot section includes a combiner tube to combine the at least two filaments, which are then mixed together in a mixing chamber by a mixing shaft. The molten filament mixture is then extruded out of a nozzle. The print head apparatus further includes lifter discs that can lift the mixing shaft out of the chamber, creating a negative pressure in the chamber and sucking the remaining molten filament from the nozzle upwardly and back into the apparatus to reduce oozing and stringing.

### CROSS-REFERENCE TO RELATED APPLICATION

This application claims priority of U.S. Provisional Patent Application No. 62/336,804, filed on May 16, 2016.

### FIELD OF THE DISCLOSURE

This disclosure relates generally to the field of additive manufacturing and, more specifically to a fused filament fabrication color extruder and method for three dimensional printing.

### BACKGROUND OF THE DISCLOSURE

As computers within manufacturing have advanced so have methods of producing three-dimensional (3D) computer models and the ability to manufacture these models into objects using rapid prototyping techniques of which additive manufacturing is one of these techniques.

Therefore, there remains a need to produce a multi-filament miniature single hot end color mixing extruder to address weaknesses in current system. The present disclosure relates to these needs.

### SUMMARY OF THE DISCLOSURE

In an aspect, the present disclosure provides a print head apparatus for printing a multi-coloured three-dimensional object, comprising: a filament routing block positioned in a cold section of the apparatus to receive at least two filaments; a gasket connected to the filament routing block and positioned in a transition section of the apparatus, the gasket further comprised of at least two tunnels to receive the at least two filaments; a mixing chamber connected to the gasket by a combiner tube, the mixing chamber and combiner tube positioned in a hot section of the apparatus, the hot section heated at a temperature to melt the at least two filaments; a mixing shaft operatively connected to a motor, the mixing shaft further comprising a lower section positioned inside the mixing chamber to mix the at least two filaments; and, a nozzle connected to the mixing chamber to extrude the at least two filaments.

In another aspect, the present disclosure provides a method for printing a multi-coloured three-dimensional objection, the steps comprising: feeding at least two filaments separately into a filament routing block, the filament routing block positioned in a cold section of a print head apparatus; transitioning the at least two filaments separately from a solid state to a partially molten state in a gasket; combining the at least two filaments in a partially molten state in a combiner tube and heating the at least two filaments to a molten state in the combiner tube; using a mixing shaft to mix and heat the at least two filaments in a mixing chamber; extruding the at least two filaments out of a nozzle; and, retracting the mixing shaft to reduce stringing and oozing of the at least one filament.

In another aspect of the disclosure, there is provided an apparatus for producing a multi-coloured three-dimensional (3D) printed object including a routing block for receiving a plurality of filament feed tubes, the filament feed tubes including different colored filaments; a mixing apparatus, the mixing apparatus including a mixing chamber, a mixing shaft and a set of lifter discs; wherein when filaments are inserted into the mixing chamber to produce a mixed color filament, the mixing shaft is lifted upwardly by the lifter discs to create a negative pressure within the mixing chamber to reduce stringing or oozing when the mixed color filament is extruded.

In a further aspect, the mixing apparatus includes a hot zone including the mixing chamber; a transition zone; and a cooling zone. In yet another aspect, a routing block is located within the cooling zone. In an aspect, the transition zone is between the hot zone and the cooling zone.

In yet a further aspect, the transition zone includes a gasket portion for separating the cooling zone and the hot zone. In another aspect, the hot mixing chamber further includes a combiner tube connected to the gasket portion. In yet another aspect, the apparatus includes a nozzle for extruding the mixed color filament from the mixing chamber. In yet another aspect, the routing block directs the different colored filaments to the transition zone. In another aspect, the different colored filaments are warmed to a partially molten state within the transition zone. In yet a further aspect, the different colored filaments in the partially molten state are transferred to the combiner tube for heating of the different colored filaments in the partially molten state. In another aspect, the apparatus further includes an ooze flap to rotate flushly against the nozzle.

In another aspect, there is provided a method of 3D printing including warming a plurality of different colored filaments from a solid state to a partially molten state in a gasket; heating the plurality of different colored filaments from a partially molten state to a molten state in a combiner tube; mixing the plurality of different colored filaments to produce a mixed colored filament in a mixing chamber; generating a negative pressure within the mixing chamber; and extruding the mixed colored filament for printing.

In a further aspect, warming of the plurality of different colored filaments creates a plug for the mixing chamber. In another aspect, generating a negative pressure includes upwardly lifting a mixing shaft within the mixing chamber to retract the mixing shaft.

### BRIEF DESCRIPTION OF THE DRAWINGS

The disclosure will now be described in detail, with reference to the accompanying drawings of preferred and exemplary embodiments, in which:

FIG. 1 is a diagram of the full color print head according to an embodiment of the present disclosure;

FIG. 2 is an internal view of the transition zone gasket and hot end according to an embodiment of the present disclosure;

FIG. 3 is a cut away view of the mixing chamber hot end according to an embodiment of the present disclosure;

FIG. 4 is a different view of the full color print head according to an embodiment of the present disclosure;

FIG. 5 is a perspective cross-sectional view of a print head apparatus according to another embodiment of the present disclosure;

FIG. 6 is a front cross-sectional view of first and second lifter discs engaged with the mixing shaft coupling and mixing shaft of a print head apparatus according to another embodiment of the present disclosure;

FIG. 7 is a perspective cross-sectional view of a first lifter disc having a notch positioned in between a lower portion of a mixing shaft coupling and a washer and thrust bearing of a print head apparatus according to another embodiment of the present disclosure;

FIG. 8 is a front cross-sectional view of cold, transition and hot sections of a print head apparatus according to another embodiment of the present disclosure;

FIG. 9 is a front cross-sectional view of a combiner tube terminating in a mixing chamber, and having a mixing shaft positioned in said chamber of according to another embodiment of the present disclosure;

FIG. 10 is a perspective view of a gasket of a print head apparatus according to another embodiment of the present disclosure; and

FIG. 11 is a flowchart outlining a method of 3D printing.

### DETAILED DESCRIPTION

The disclosure is directed at a method and apparatus for a fused filament fabrication color extruder. In one embodiment, the apparatus find benefit in the field of additive manufacturing using an industrial robot under computer control to form successive layers of material to create a three-dimensional (3D) object from a 3D computer model. In a preferred embodiment, a deposition method of manufacturing such as fused filament fabrication is used. This disclosure relates to multiple colored materials being fused and actively mixed to produce a colorization of the manufactured 3D object as specified in the computer model.

There are many methods known in the art but this disclosure relates to fused filament fabrication using standard filaments of polylactic acid (PLA), Acrylonitrile Butadiene Styrene (ABS) or others. Typically, a filament is driven into a heated chamber where it is liquefied and then extruded out of a nozzle in a controlled manner as the nozzle is moved about a single printing plane in two dimensions, typically X and Y axes. This is repeated for subsequent planes, or layers, being stacked upon the previous planes which define a third dimension, typically in the Z axis. Currently, a single extruder is used that can print in one color, that being the color of the base material. However, there is a need for 3D printing in more than one color and ideally that the color is homogenous in a gamut subset of colors as defined by the user.

Fused Filament Fabrication (FFF) printers include an extruder having various sections. The extruder uses a motor with drive wheels to drive filament from a spool into a cold end portion of the extruder. The cold end remains at a temperature low enough that the filament will not melt or become soft. The filament is then passed into a hot end portion or chamber. This portion is typically electrically heated and temperature monitored and controlled to within a few degrees of a desired set point. The filament becomes molten and liquefies in the hot end. The pressure exerted from the cold filament forces the liquid out of the hot end nozzle tip. The tip opening is very small and is typically less than 1 mm. The rate in which the filament is driven controls the amount of material that is deposited during the print. The hot end chamber can be evacuated to reduce or prevent oozing by retracting the filament from the cold end by reversing the motor, thus reducing the liquid pressure. The ability to retract filament from the extruder has been supported in the free software program slic3r.exe since about November 2011. The program slic3r is used to convert a 3D model into machine instructions to operate a FFF printer.

The disclosure is directed at a system, apparatus and method for 3D printing an object in full color using a mixing head to blend multiple coloured filaments. In the preferred embodiment, the full color mixing head is a system for blending five (5) different colors of filament and extruding the resultant homogeneous mix in real time that results in a new color being extruded. In a preferred embodiment, the five colors are magenta, cyan, yellow, black, and white (CMYKW). Mixing these 5 colours allows the 3D printing in a gamut subset of color hue, tone, tint, and shade. These filaments may be, but are not limited to, standard PLA or ABS materials.

The full color mixing head has 3 sections, portions or chambers, as is known in the art (hot, transition, and cold). The hot section is where the filament is melted and mixed. The transition section is where the semi-melted and swollen filament creates a plug that is like a perpetual syringe allowing the molten filament to be pushed downward and out of the nozzle tip. The transition zone is enhanced by using a gasket with 5 holes for each of the filaments to pass through. The gasket is pressed into the hot end on one side and the cooling block on the other, such as the top, side. The hot section is preferably very compact so that the filaments are close, or very close, together. This compactness may create a problem for removing the heat as it transfers into the gasket, however in the preferred embodiment the heat is removed by liquid flowing through a series of pathways evenly routed through the cold block. A worker skilled in the art would appreciate that although the gasket is preferably constructed of stainless steel or Teflon™, it can be constructed of any thermally insulating material provided that such a material creates the proper conditions described below for a transition zone.

A novel method of clamping the 5 filament feed tubes allows the cold block to be compact to maintain a straight path for the filament to be guided through the head. The straight path is preferred because the hard filament may be too stiff to be routed through an S-shaped bend. Clamping is therefore accomplished with a custom nut and tool with a sharp collar. As the nut is tightened in the center of the feed tube arrangement, the sharp collar puts pressure outwards concentrically and evenly against all 5 feed tubes which clamps them in place against the upward force from the filament feeding. This provides for a significant miniaturization of the full color head.

When the head is in use, not all filaments are fed simultaneously, although they could be. The firmware of the 3D printer takes a CMYKW value and proportions the correct amount of each of the filaments to create that color. As the filament is extruded it passes through the cooling block, through the stainless steel gasket, starts to expand, becomes molten, and then enters the mixing chamber. The mixing chamber has a rod with a conical end. The mixing rod is rotated by a motor mounted above the cooling block and fixed to the head by a bracket. As the mixing rod is rotated, the colors from each of the 5 tubes surrounding the circumference of the mixing chamber are mixed together. The shear force between the walls of the mixing chamber and the surface of the mixing rod cause the filaments to mix together. The pressure of the filament extrusion forces the molten plastic downward and out the nozzle. While the filament is moving downward toward the nozzle further vertical shear forces are created.

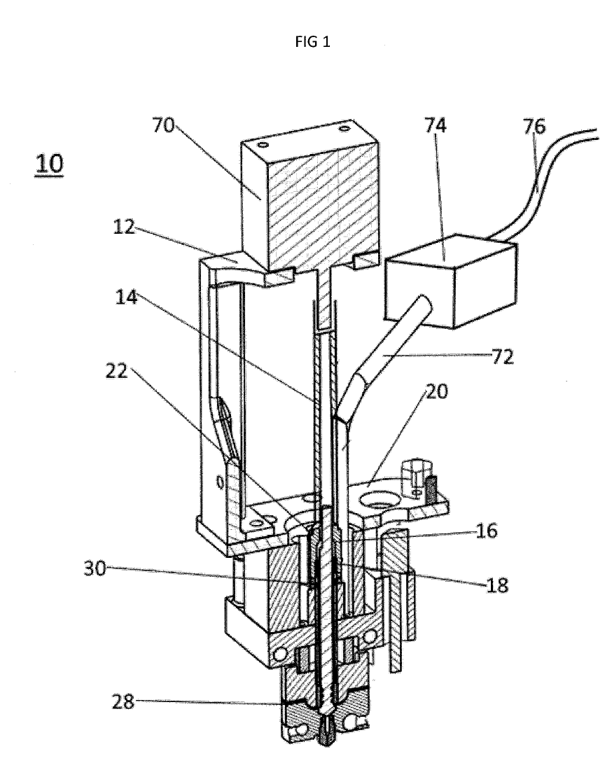

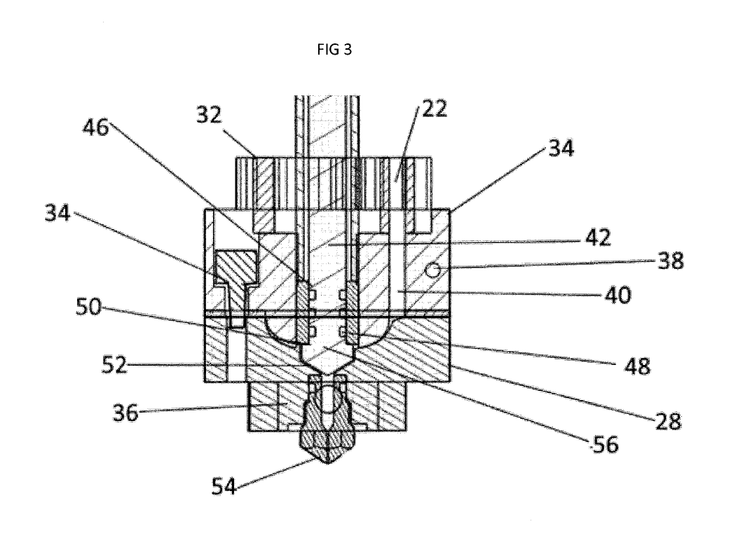

Turning to FIG. 1, and referencing FIG. 3, a first embodiment of the full color print head is shown. The print head system 10 includes a frame 20 attached to the 3D printer, not shown. The mixing motor 70 is held in a mixing motor bracket 12 and coupled to the mixing shaft 14. In one embodiment, the mixing motor 70 spins at 15 to 150 RPM and is controlled by the 3D printer firmware and computer. However, it will be understood that the mixing motor may operation at other RPM. The mixing shaft 14 is supported by a bearing 18 attached to the frame 20. The spring 16 on the mixing shaft 14, creates positive pressure to hold the O-ring 50 inside the mixing chamber 52 as shown in FIG. 3. The filament feed tubes 72, only one shown for clarity, go into the five holes 22 located radially around the mixing shaft 14. The tubes 72 are inserted such that the filament 76, is fed straight down. The filament 76 is driven into the feed tubes 72 by drive motors and wheels 74 at a feed rate as determined by the 3D printer firmware. The custom nut and tool 30 has a sharp collar. As the nut 30 is tightened in the center of the feed tubes 72 around mixing motor shaft 14, the sharp collar puts pressure outwards concentrically and evenly against all 5 feed tubes 72. This clamps the feed tubes 72 in place against the upward force from the filament feeding by drive 74. The feed tubes 72, holes 22 and clamping nut 30 represent the cold end of the color mixing extruder.

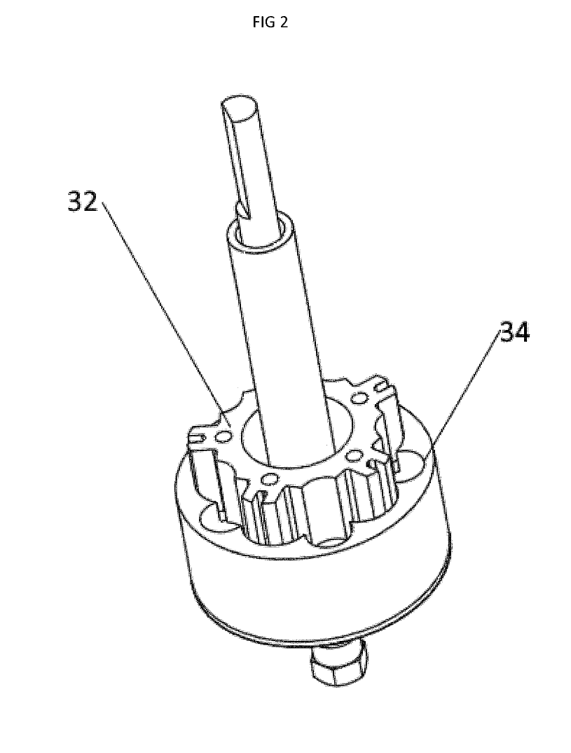

Turning to FIG. 2, a schematic diagram of the transitional stage between the hot and cold ends is provided. The stainless steel gasket 32 creates a separation between the cooling section, keeping the cool end cold; separated from the heater in the hot end 34 so that the hot end is not cooled by the liquid, allowing it to get hot. This gasket 32 creates a transition zone plug in the molten filament 76. This plug performs like a perpetual syringe pushing the liquid filament through the hot end 34. The hot end 34 is manufactured in two pieces to accommodate machining.

The color blending mixing operation is illustrated in FIG. 3. The cut away view of the transition zone gasket 32 with filament holes 22 is shown on the top of the diagram. Filament 76 is driven through holes 22 into the elbow region 40. The filament 76 is melted in the region 40 as it moves into the mixing chamber 52. As stated above the molten filament expands to form a plug in the transition gasket 32 that in turn pushes the liquid filament out of section 40 into the mixing chamber 52. The hot end 34 in two pieces is preferably sealed with silicone 38 (although other sealants may be contemplated) and clamped together with a set of fasteners, such as the five screws 44. The hot end is heated with electricity passing through a heater wire, such as a Ni-Chrome heater wire, 36 potted into the bottom section of the hot end 34. Note that, in the current embodiment, there are five of each feed tubes 72, filaments 76, and melting cavities 40 although other numbers may be contemplated. As different proportions of the five liquid filaments enter the mixing chamber 52 they are blended together by the conical rod 56 portion of the mixing shaft 14. The shear force between the walls of the mixing chamber 52 and the surface of the mixing rod conical end 56 cause the filaments to mix together. The retaining clip 48 holds the mixing shaft 14 assembly together against the spring pressure 16 FIG. 1. The brass bushing 46 holds the retaining ring and subsequently the sealing O-ring 50 into position. O-ring 50 seals the mixing chamber so molten mixed filament moves downward. The pressure of the filament extrusion forces caused by the filament drive wheels 74 (as shown in FIG. 1) on filament 76 forces the molten plastic downward and out of the nozzle 54.

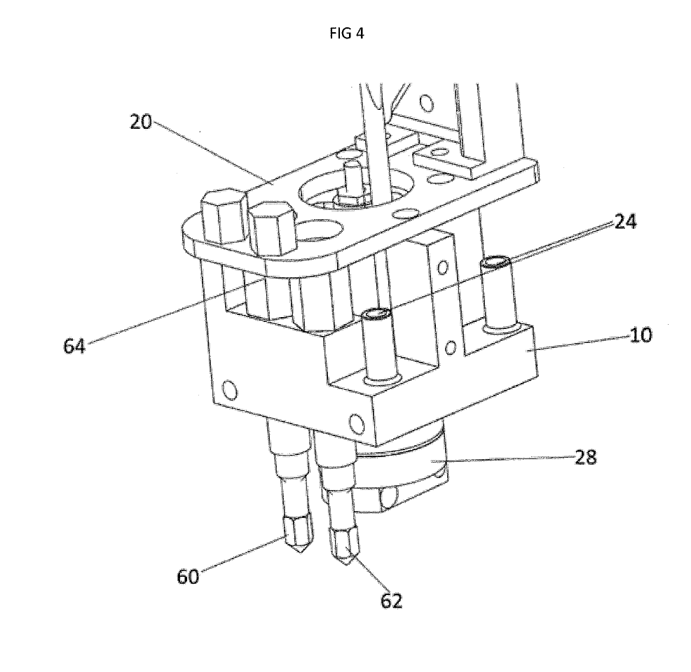

Turning now to FIG. 4, a perspective view of the print head is shown. A description of how the cooling operation is performed is also discussed below. This figure shows the back of the print head 10. Ports 24 are inlets and outlets for liquid cooling that will cool the cool end. In this embodiment, the print head 10 has two additional conventional single filament hot ends without mixers. The one hot end 60 is used to print optional support material such as dissolvable filament. The second hot end 62 is used to print NinjaFlex material, such material having different properties than the filament that passes through the mixing hot end 28. All the hot ends, 62, 60 and 28 are individually translated with lifting servos 64, moving the hot ends up or down in the Z axis by a designated amount. This is used to reduce or prevent dragging the inactive nozzles of 62, 60 or 28 across the printed plane.

In the preferred embodiment the mixer motor 70 is attached to the mixer shaft 14. This requires sealing the shaft to reduce or prevent liquid filament from leaking out of the top of the chamber. It is also possible to place permanent magnets on the shaft 14 and have it entirely enclosed by the mixing chamber 52. Magnetic coils can be placed outside of the chamber to spin the permanent magnet on shaft, forming a sealed electric motor. In a preferred embodiment, the chamber is non-ferrous.

The preferred embodiment uses 5 filaments, cyan, magenta, yellow, white and black. It is also possible to add a 6th material or filament that is transparent to allow translucent color.

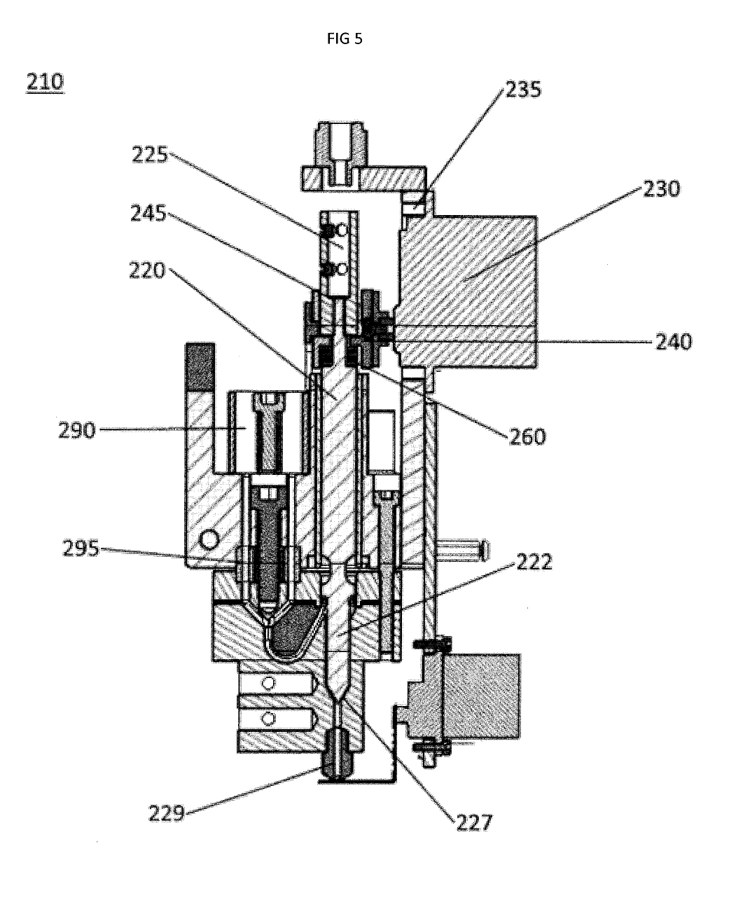

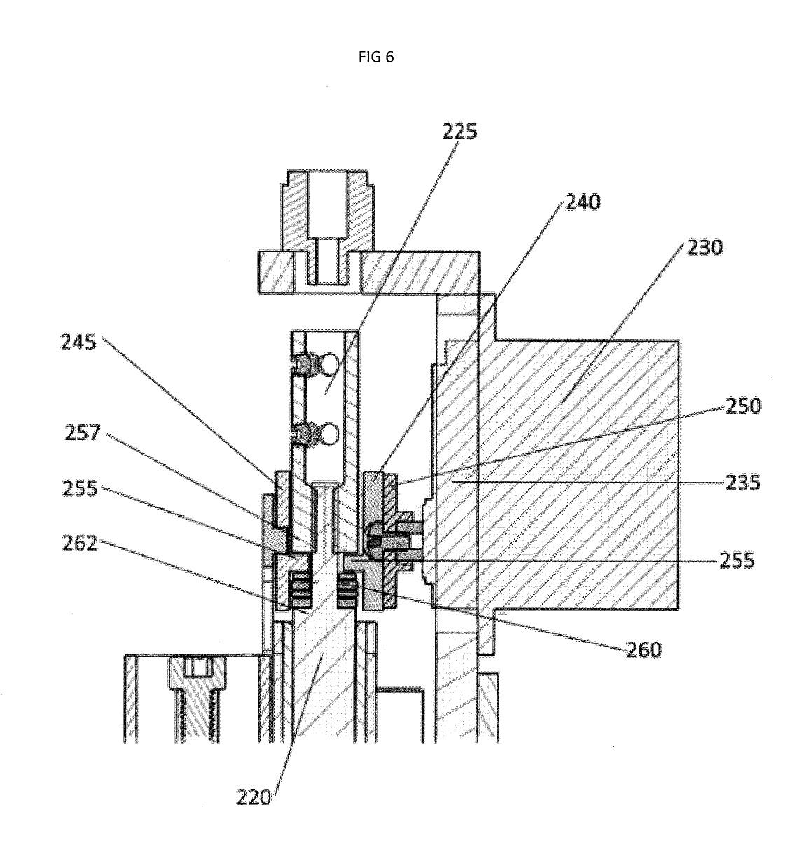

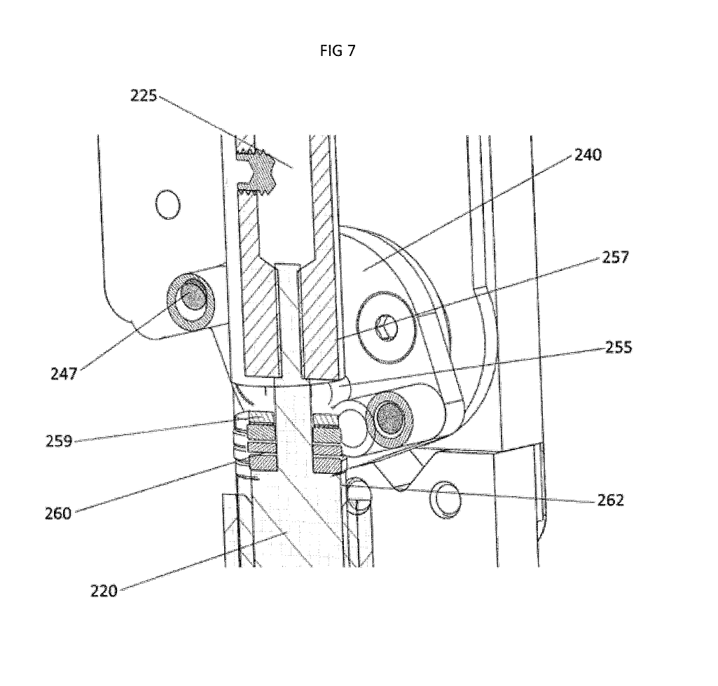

With reference to FIGS. 5, 6 and 7 and according to another embodiment of the present disclosure, the print head system 210 is comprised of a mixing motor (not shown) fastened to the print head system 210 such as via a motor bracket (not shown). The mixing motor (not shown) is operatively engaged to a mixing shaft 220 by via a mixing shaft coupling 225, the mixing shaft 220 being in threaded engagement with the mixing shaft coupling 225. As such, actuating the mixing motor (not shown) rotates the mixing shaft coupling 225 and correspondingly rotates the mixing shaft 220. A lower section 222 of the mixing shaft 220 terminates in a mixing chamber 227, where molten filaments of different colours are blended together to create the desired printing coloured material, which exits the print head system 210 via a nozzle 229. This blending technique will be further described below. The print head system 210 is further comprised of a servo motor 230 connected to the print head system 210 by a servo bracket 235. One function, among many, of the servo motor 230 is to retract the mixing shaft 220 upwardly, away from the nozzle 229 when printing is complete or if a different material colour is required. As such, the servo motor 230 is operatively engaged to the mixing shaft 220 by a servo-to-lifter coupling 250 connected to first and second lifter discs 240, 245. The first and second lifter discs 240, 245 are generally oval-shaped and further comprised of notches 255, the notches 255 being offset from the center of the first and second lifter discs 240, 245. A standoff 247 is positioned on a far side of the mixing shaft coupling 225 and connects the first and lifter disc 240 to the second lifter disc 245. Although not shown, a second standoff may be positioned on the near side of the mixing shaft 225. The notches 255 are sandwiched in between a lower portion 257 of the mixing shaft coupling 225 and washer 259 adjacent a thrust bearing 260. In turn, the thrust bearing 260 is positioned against an upper portion 262 of the mixing shaft 220 and the washer 259. When the first and second lifter discs 240, 245 are rotated by the servo motor 230, the notches 255 are similarly forced to rotate either clockwise or counter-clockwise. However, the notches 255 are confined in the area in between the washer 259 and the lower portion 257 of the mixing shaft coupling 225. Consequently, continued rotation of the first and second lifter discs 240, 245 similarly rotates the notches 255 and creates an upward force from the notches 250 on the lower portion 257 of the mixing shaft coupling 225. As the mixing shaft coupling 225 is threaded into the mixing shaft 220, the mixing shaft 220 is lifted upwardly as well and away from the nozzle 229. A bushing (not shown) is positioned around the mixing shaft 220 and serves to restrict or reduce the mixing shaft 220 to upwards and downwards movement only, and therefore the mixing shaft 220 is preferably always centered in the print head system 210. The purpose of the upward and downward movement of the mixing shaft 220 will be further described below. A worker skilled in the art would appreciate that the first and second lifter discs 245, 250 can rotate either clockwise or counter-clockwise, such that the mixing shaft 220 is either lifted upwardly or allowed to return downwardly toward the nozzle 229.

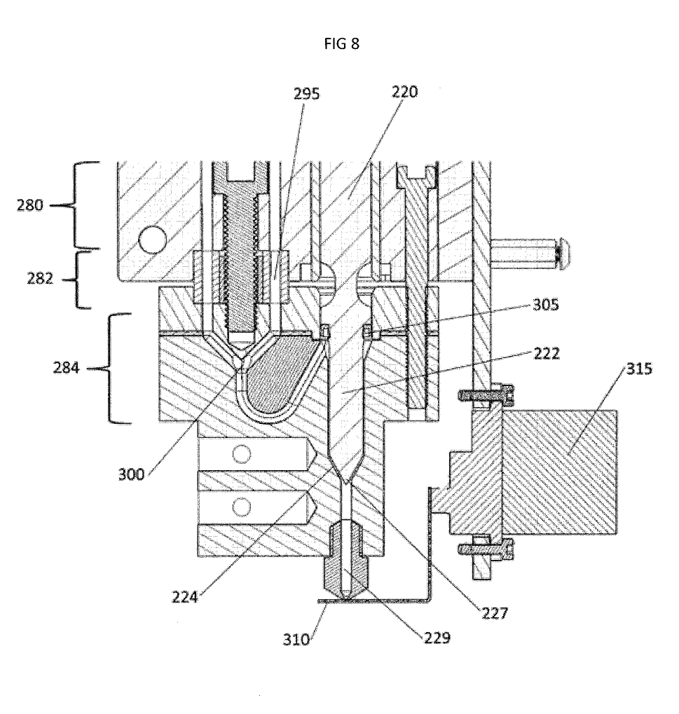

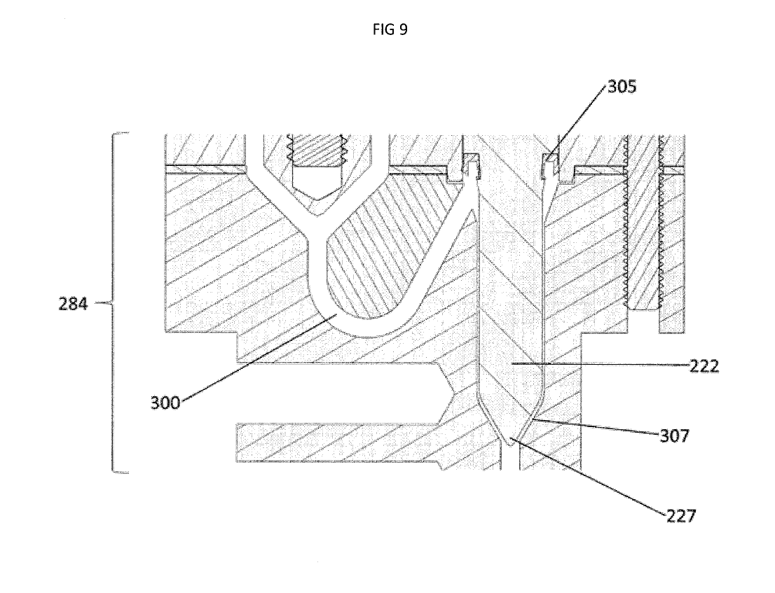

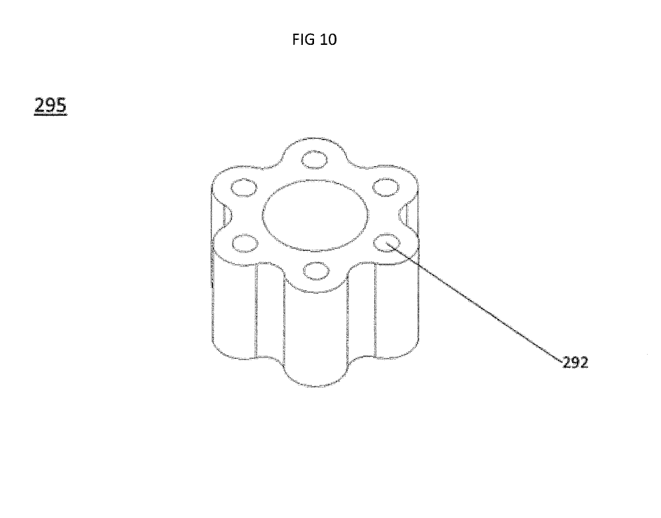

With reference to FIGS. 5, 8, 9 and 10, the print head system 210 includes a cold section 280, a transition section 282 and a hot section 284. The cold, transition and hot sections 280, 282, 284 serve the same purpose as described in the previous embodiment in FIGS. 1 to 4. The cold section 280 and hot section 284 are commonly referred to as a cold end and a hot end, the cold and hot ends being cool or hot blocks encasing some of the print head system 210 equipment. Each filament is inserted into a separate path (not shown) of a filament routing block 290, which is positioned in the cold section 280 of the print head system 210. The filaments are fed into the paths such as by one or more drive wheels (not shown). Although the drive wheels are not shown in this embodiment; such drive wheels are known in the art and shown as 74 in FIG. 1. Although the filament routing block 290 is constructed and arranged to have six paths receiving six individual strands of different coloured filament as described above, fewer or additional paths for fewer or additional colours of filament could be used. This particular print head system 210 uses the colours cyan, magenta, yellow, white, black and translucent. Once through the routing block 290, the filaments pass through six separate tunnels 292 of a star gasket 295. The star gasket 295 is positioned in the transition section 282 of the print head system 210. From there, the six tunnels 292 converge into a single filament combiner tube 300, the single filament combiner tube 300 positioned in the hot section 284 of the print head system 210. As the single filament combiner tube 300 is heated, the six filaments become heated to a melting point and are combined to form a single unmixed filament strand of molten material. The combiner tube 300 has a general U-shape to make the print head system 210 more compact and allow sufficient time for the six filaments to transition to a molten state. The combiner tube 300 terminates into the mixing chamber 227, such that the single unmixed filament is guided into the mixing chamber 227 near a chamber seal 305. The mixing chamber 227 is defined by the area in between a lower section 222 of the mixing shaft 220 and a cavity 307 in the hot section 284. Once in the mixing chamber 227, the unmixed filament is mixed together by rotation of the mixing shaft 220, and extrudes below out of the nozzle 229. The chamber seal 305 can be a spring energized seal, and the purpose of the chamber seal 305 is to reduce or prevent the molten filament from flowing upwardly and out of the hot section 284. Once the printing is complete, or if a different section is to be printed with a different colour, retraction of the molten filament occurs before it is re-extruded with the proper colour or in the proper spatial zone. In normal 3D printers, retraction is performed immediately prior to non-printing movements of the extrusion nozzle. The retraction means that the filament extrusion direction is reversed by an extruder driver wheel reversing direction and pulling the filament out of the hot section. However, in the present disclosure, such a retraction is not possible as the combiner tube 300 in the hot section 284 is too long and does not sufficiently stop the flow of the unmixed filament.

Therefore, and with further reference to FIGS. 5 to 10, the print head system 210 is constructed and arranged to provide an improved means of filament retraction. During operation, there is a constant air pressure in the mixing chamber 227 caused by forcing the unmixed filament from the combiner tube 300 into the mixing chamber 227 at a faster rate than the rate by which the mixed filament is extruded from the nozzle 229. Such a pressure acts on the mixing shaft 220 to bias it upwardly and away from the nozzle 229, and similarly acts on the unmixed filament to bias it rearwardly and back into the star gasket 295. As was previously discussed, the filaments are in a transition state from solid to molten material in the star gasket 295. In this transition state, each filament swells and fills the tunnels 292 of the star gasket 295. This swelling of the filaments acts as a natural plug to resist back pressure from the unmixed filament and prevent its backflow. Meanwhile, the mixing shaft 220 remains in place by virtue of first and second lifter discs 240, 245. The thrust bearing 260 allows the mixing shaft 220 to rotate axially even while the mixing shaft 220 is under pressure from the mixing chamber 227. When the servo motor 230 rotates the servo-to-lifter coupling 250, the first and second lifter discs 240, 245 pull the entire mixing shaft 220 upwardly. Pulling the entire mixing shaft 220 upwardly creates a negative pressure in the mixing chamber 227, therefore sucking the molten filament out of the nozzle 229. This negative pressure created efficiently reduces or eliminates any unwanted stringing and oozing that may otherwise occur from the extruded filament. To further reduce or prevent unwanted oozing, the print head system 210 may further include an ooze flap 310 controlled by a second servo motor 315 connected to the print head system 210. The ooze flap 310 rotates flush against the nozzle 229 to reduce or prevent any additional flowing of the filament, and rotates away from the nozzle 229 during printing.

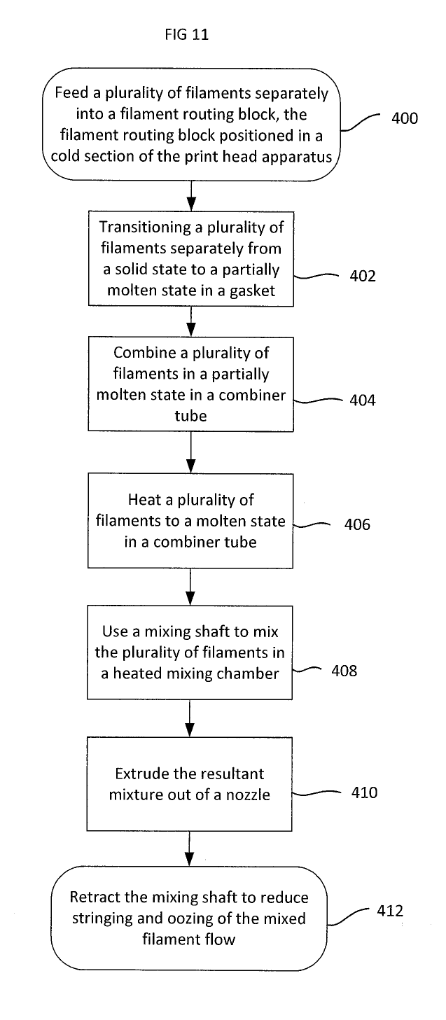

Turning to FIG. 11, a flowchart outlining one method of 3D printing using the apparatus of the disclosure is shown. As will be understood, other methods may be contemplated. Initially, a plurality of filaments are separately fed into a filament routing block that is positioned in a cold section of a print head apparatus (400). The plurality of filaments are then separately transitioned from a solid state to a partially molten state (402). In the current embodiment, this is performed in a gasket.

After, the molten state filaments are combined into a combiner tube (404). The filaments within the combiner tube are then heated (406). The heated filaments are then mixed in a heated mixing chamber (408). This may be performed by a mixing shaft. The resultant mixture is then extruded out of the mixing chamber (410). The mixing shaft can then be retracted to reduce stringing and oozing of the resultant mixture (412).

In the preceding description, for purposes of explanation, numerous details are set forth in order to provide a thorough understanding of the embodiments; however the specific details are not necessarily required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

The above-described embodiments are intended to be examples only. Alterations, modifications and variations can be effected to the particular embodiments by those of skill in the art without departing from the scope, which is defined solely by the claims appended hereto.

What is claimed is:

1. An apparatus for producing a multi-coloured three-dimensional (3D) printed object comprising:
a routing block for receiving a plurality of filament feed tubes, the filament feed tubes including different colored filaments;
a mixing apparatus, the mixing apparatus including a mixing chamber, a mixing shaft and a set of lifter discs;
wherein when filaments are inserted into the mixing chamber to produce a mixed color filament, the mixing shaft is lifted upwardly by the lifter discs to create a negative pressure within the mixing chamber to reduce stringing or oozing when the mixed color filament is extruded.

2. The apparatus for claim 1 wherein the mixing apparatus comprises:
a hot zone including the mixing chamber;
a transition zone; and
a cooling zone.

3. The apparatus of claim 2 wherein the routing block is located within the cooling zone.

4. The apparatus of claim 3 wherein the transition zone is between the hot zone and the cooling zone.

5. The apparatus of claim 4 wherein the transition zone comprises:
a gasket portion for separating the cooling zone and the hot zone.

6. The apparatus of claim 5 wherein the hot mixing chamber further comprises a combiner tube connected to the gasket portion.

7. The apparatus of claim 6 further comprising a nozzle for extruding the mixed color filament from the mixing chamber.

8. The apparatus of claim 6 wherein the routing block directs the different colored filaments to the transition zone.

9. The apparatus of claim 8 wherein the different colored filaments are warmed to a partially molten state within the transition zone.

10. The apparatus of claim 9 wherein the different colored filaments in the partially molten state are transferred to the combiner tube for heating of the different colored filaments in the partially molten state.

11. The apparatus of claim 7 further comprising an ooze flap to rotate flushly against the nozzle.

12. A method of 3D printing comprising:
warming a plurality of different colored filaments from a solid state to a partially molten state in a gasket;
heating the plurality of different colored filaments from a partially molten state to a molten state in a combiner tube;
mixing the plurality of different colored filaments to produce a mixed colored filament in a mixing chamber;
generating a negative pressure within the mixing chamber; and
extruding the mixed colored filament for printing.

13. The method of claim 12 wherein warming of the plurality of different colored filaments creates a plug for the mixing chamber.

14. The method of claim 12 wherein generating a negative pressure comprises:
upwardly lifting a mixing shaft within the mixing chamber to retract the mixing shaft.
